(19) United States
(12) Patent Application Publication
(10) Pub. No.: US 2015/0233507 A1
(43) Pub. Date: Aug. 20, 2015

(54) Connecting Device for the Fluidic Connection of a Fluid Pipe Section to a Further Fluid Pipe Section

(71) Applicant: MANN+HUMMEL GMBH, Ludwigsburg (DE)

(72) Inventors: Petra Skorpíková, Nasimerice (CZ); Martin Kopriva, Hrusovany u Brna (CZ)

(21) Appl. No.: 14/623,801

(22) Filed: Feb. 17, 2015

(30) Foreign Application Priority Data
Feb. 20, 2014 (DE) 102014002240.4

(51) Int. Cl. F16L 21/08

(52) U.S. Cl. CPC F16L 21/08

(57) ABSTRACT

The invention relates to a connecting device (10) for connecting two pipe end sections (12, 13) in a fluidically sealed manner. The connecting device (10) has retaining element which can be fitted to a first pipe end section (12) by means of a bayonet connection. The retaining element has a strap (46) which can be fixed to a second pipe end section (13) by means of a screw (58) of the connecting device (10). The connecting device (10) is therefore particularly simple from a constructive point of view, creates a sealed connection, and can also be easily fitted in restricted condition.

### TECHNICAL FIELD

The invention relates to a connecting device for the fluidic connection of a fluid pipe section to a further fluid pipe section, in particular of a turbocharger having a charge air pipe.

### BACKGROUND

From the prior art, it is known to fluidically connect a turbocharger to a further device, for example to a resonator, by means of a charge air pipe. Such a charge air pipe is also referred to as a charge air hose.

US 2012/0298063 A1 discloses a connecting device for connecting a charge air pipe to a turbocharger. Here, the connecting device has a bayonet connection.

Furthermore, a connecting device for connecting a charge air pipe to a turbocharger which has a sealing ring has been disclosed in US 2007/0216161 A1.

Finally, connecting devices in the form of “screw solutions” which have a strap, wherein the strap connects two pipe end sections and is fixed to a pipe end section by means of a screw in each case, are used on the market.

The known connecting devices must either be produced laboriously and expensively or, ultimately, can only be fitted in a circuitous manner due to the restricted installation conditions in the engine compartment of a motor vehicle. At the same time, the costs for manufacturing such a connecting device are critical, mainly because the connecting devices in question are mass-produced products.

### SUMMARY OF THE INVENTION

The invention is based on the object of providing a connecting device for the fluidic connection of a fluid pipe section to a further fluid pipe section, for an example, a fluidic connection of a turbocharger to a charge air pipe in such a way that the connection can be produced cost effectively and is also easy and convenient to fit.

This object is achieved by a connecting device with the characteristics of Claim 1. The dependent claims specify expedient developments.

The connecting device according to the invention for the fluidic connection of a fluid pipe section to a further fluid pipe section, in particular for the connection of a turbocharger to a charge air pipe, comprises a first pipe end section and a second pipe end section, wherein a retaining element of the connecting device, which can be rotated at least to a limited extent about the longitudinal axis of the first pipe end section, is arranged on the first pipe end section, wherein the retaining element and the first pipe end section have a plurality of projections which form a bayonet connection between the first pipe end section and the retaining element, wherein the retaining element has a strap with a through-opening into which a screw of the retaining element is fed, and wherein the second pipe element has an opening into which the screw can be inserted.

The connecting device therefore has two pipe end sections which can be connected to one another. A first pipe end section has a retaining element which can be rotated at least to a limited extent about the longitudinal axis of the first pipe end section. The retaining element has a strap which is provided with a through-opening. A screw is fed into the through-opening. The screw therefore extends through the through-opening of the strap of the retaining element and can be inserted, i.e. screwed, into an opening of the second pipe end section. For this purpose, the opening of the second pipe end section can be provided with a female thread which corresponds to a male thread of the screw. A bayonet connection is formed between the retaining element and the first pipe end section by means of a plurality of projections. The bayonet connection limits at least the possibility of movement of the retaining element in the direction of the pipe end of the first pipe end section in the connected state of the connecting device. The connection of the two pipe end sections therefore takes place from the first pipe end section via the bayonet connection to the retaining element with the strap and further to the screw which is inserted into the second pipe end section.

The connecting device has a simple design structure and can therefore be produced cost-effectively. Furthermore, it can be easily fitted in a restricted engine compartment. The retaining element only has to be placed onto the first pipe end section and subsequently rotated relative to the first pipe end section about its longitudinal axis in order to bring the bayonet connection into its locking position and, by this means, to couple the retaining element tightly to the first pipe end section. It is therefore not necessary to rotate the whole pipe end section in order to close the bayonet connection. The connecting device is finally fixed by screwing the single screw into the opening of the second pipe end section. As a result, the two pipe end sections are connected tightly and in a fixed rotational relationship to one another. This saves a screw compared with known “screw solutions” and the overall assembly is simplified.

The connection is formed particularly stably when the projections of the retaining element which constitute a part of the bayonet connection are designed as one part, i.e. in one piece, with the further components of the retaining element. Alternatively or in addition, for stable formation of the connection, the projections of the first pipe end section are preferably designed as one part with the further components of the pipe end section.

The pipe end sections can preferably be slid inside one another. For example, the first pipe end section can be fed axially into the second pipe end section. Alternatively, the second pipe end section can be fed into the first pipe end section. This enables a particularly fluid-tight connection to be achieved.

In order to further simplify the handling of the connecting device for a fitter, the first pipe end section can have at least one stop which limits the rotation of the retaining element about the first pipe end section. As a result of this, the fitter only has to turn the retaining element “as far as the stop” in order to ensure the correct closure of the bayonet connection.

According to the invention, the strap can have a guide section for locating the correct assembly position of the strap on the second pipe end section. In doing so, the guide section can be designed as an angled edge section of the strap which interacts with a guide surface of the second pipe end section.

The retaining element can have a fixing section for mounting the retaining element on the first pipe end section which encompasses more than half the circumference of the first pipe end section. The retaining element can therefore be designed in the form of a clamp which can be pressed onto the first pipe end section.

In order to achieve a particularly secure connection, the fixing section is preferably substantially ring-shaped, wherein the fixing section fully encompasses the circumference of the first pipe end section.

The strap constitutes a particularly heavily stressed part of the connecting device according to the invention. A design of the connecting device which is at the same time strong and cost-effective is enabled in that the strap is made of sheet metal.

The stability of the connecting device is particularly high when the strap is formed as one part with the fixing section. In particular, the retaining element can be made of metal or a fiber composite material.

An elastic sealing element can be arranged or formed between the first pipe end section and the second pipe end section in order to achieve a particularly airtight connection of the pipe end sections. In particular, the elastic sealing element can be a radial sealing element.

The elastic sealing element can be formed as one part with the connecting device. On the other hand, the sealing element can also be designed in the form of a sealing ring so that a standardized sealing element which can be purchased inexpensively is used.

In an embodiment of the connecting device according to the invention for the fluidic connection of a turbocharger to a charge air pipe, the first pipe end section can be a pipe end section of the turbocharger and the second pipe end section a pipe end section of the charge air pipe. At the same time, the first pipe end section can be formed as one part with a turbocharger housing.

Alternatively, in the embodiment of the connecting device according to the invention for the fluidic connection of a turbocharger to a charge air pipe, the first pipe end section can be a pipe end section of the charge air pipe and the second pipe end section a pipe end section of the turbocharger. At the same time, the second pipe end section can be formed as one part with a turbocharger housing.

The connecting device according to the invention can be used for connecting pipes for channeling air. Furthermore, the connecting device can be designed for connecting pipes for channeling other media.

### BRIEF DESCRIPTION OF THE DRAWINGS

Further characteristics and advantages of the invention can be seen from the following detailed description of an exemplary embodiment of the invention based on the figures, the drawing, which shows the details essential to the invention, and from the claims.

The characteristics shown in the drawing are presented in such a way that the special features according to the invention can be made clearly visible. The different characteristics can be realized individually in their own right or jointly in any combination in variants of the invention.

The drawing shows the assembly of a connecting device according to the invention in single steps (FIG. 2-5) and the finally assembled connecting device (FIG. 1).

In detail:

FIG. 1 shows a perspective view of a connecting device in the connected state;

FIG. 2 shows a perspective view of a first pipe end section of the connecting device when slipping on a retaining element;

FIG. 3 shows a perspective view of the first pipe end section with the retaining element fitted;

FIG. 4 shows a perspective view of the connecting device when sliding a second pipe end section onto the first pipe end section; and

FIG. 5 shows a perspective view of the connecting device when fitting a screw for fixing a strap of the connecting device to the second pipe end section.

### DETAILED DESCRIPTION OF THE INVENTION

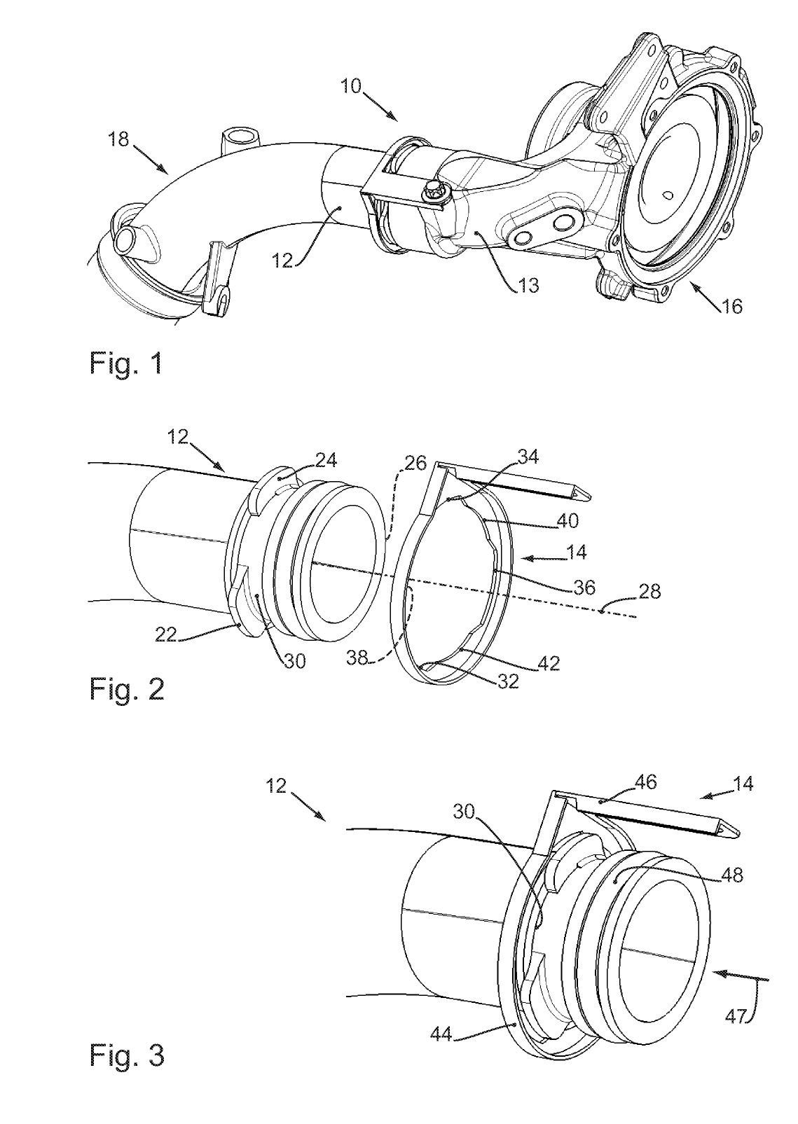

FIG. 1 shows a connecting device 10 according to the invention in the connected state. In the illustrated example, we show a connecting device of a turbocharger to a charge air pipe. The connecting device 10 connects a first pipe end section 12 to a second pipe end section 13. The second pipe end section 13 is part of a turbocharger 16. The first pipe end section is part of a charge air pipe 18. The charge air pipe 18 may connect a turbocharger 16 to a resonator, a silencer or similar acoustic devices.

FIG. 2 shows the first pipe end section 12 with a retaining element 14 which can be detachably mounted onto the first pipe end section 12 by sliding the retaining element onto the first pipe end section 12 and then rotating. The first pipe end section 12 has three radially outwardly extending projections 22, 24, 26 (radial direction relative to axis 28). Because of the alignment of the perspective view, the projection 26 is hidden behind the first pipe section and is not visible in FIG. 2, therefore identified by a dashed reference line. However, projections 22 and 24 show the geometry of projection 26. The projections 22, 24, 26 are formed equidistantly with respect to the longitudinal axis 28 of the first pipe end section 12. Furthermore, the projections 22, 24, 26 may be formed equidistantly on the circumference 30 of the first pipe end section 12. The projections 22, 24, 26 of the first pipe end section 12 may be substantially rectangular.

When the retaining element 14 slides onto the first pipe section 12, the projections 22, 24, 26 of the first pipe end section 12 can be guided by matching recesses 32, 34, 36. More accurately, the projection 22 can be guided by or be slide through the recess 32, the projection 24 by or through the recess 34 and the projection 26 by or through the recess 36.

The retaining element 14 has three radially inwardly extending projections 38, 40, 42 which, in the connected state of the connecting device 10 (see FIG. 1), engage behind the projections 22, 24, 26 of the retaining element 12. Because of the perspective view of the retaining element 14, the projection 40 is not visible in FIG. 2 and is therefore identified a dashed reference line. In the closed state of the connecting device 10, the projection 38 engages behind the projection 22, the projection 40 behind the projection 24 and the projection 42 behind the projection 26. The projections 22, 24, 26, 38, 40, 42 therefore form connection somewhat similar to a bayonet connection. In order to achieve a particularly high strength of the connection, the projections 22, 24, 26 are formed as one part with (unitarily formed with) the first pipe end section 12 and, similarly, the projections 38, 40, 42 are formed unitarily with and as one part with the retaining element 14.

FIG. 3 shows the first pipe end section 12 with the retaining element 14 fitted thereon. It can be seen from FIG. 3 that the retaining element 14 has a substantially ring-shaped fixing section 44 which fully encompasses the outer circumference 30 of the first pipe end section 12. Alternatively, the fixing section 44 can also be designed substantially in the form of a clamp and only encompass more than half of the circumference 30 but less than the entire circumference. In the latter case, the fixing section 44 can be clipped onto the circumference 30 of the first pipe end section 12. The fixing section 44 is made of sheet metal. The fixing section 44 is made unitary as one part with a strap 46 of the retaining element 14. The fitting of the retaining element 14 onto the first pipe end section 12 is shown in FIG. 3 by an arrow 47.

In order to form a particularly well sealed connection, the first pipe end section 12 has an elastic sealing element 48, which is not shown in the subsequent figures for reasons of clarity.

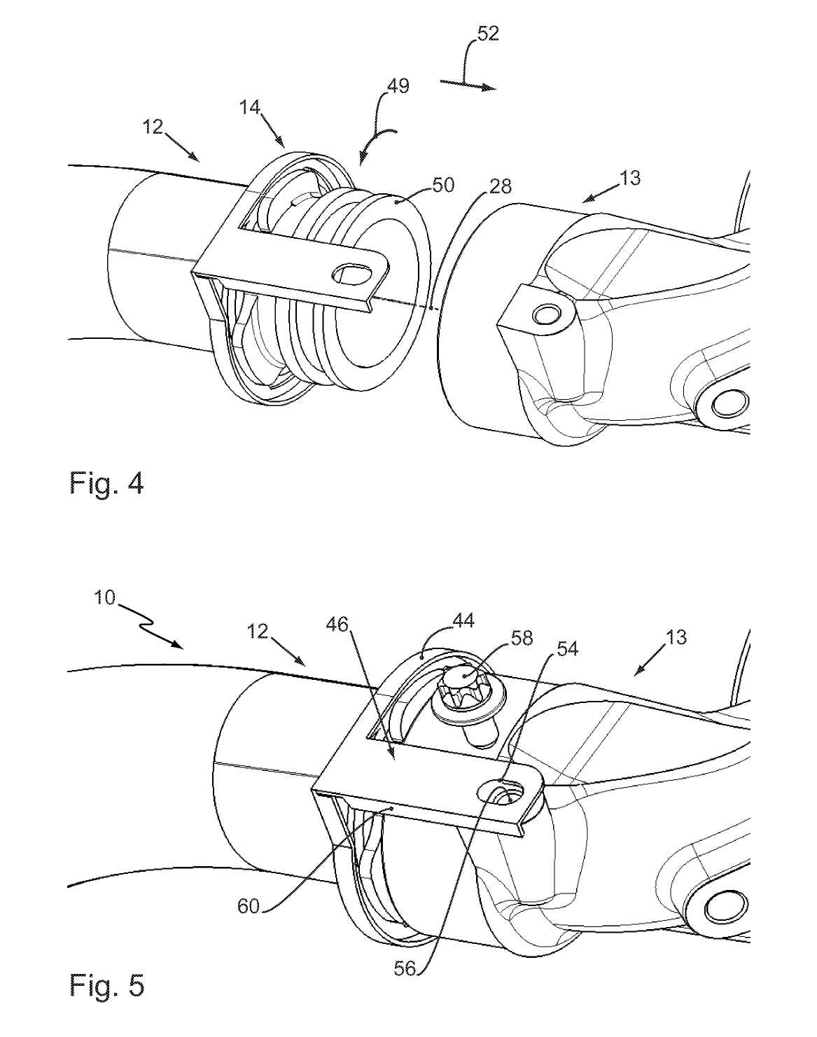

FIG. 4 shows the second end pipe section 13 and the first end pipe section 12 with the retaining element 14 arranged thereon. By comparing FIG. 4 with FIG. 3, it can be seen that the retaining element 14 has been rotated about the longitudinal axis 28 of the first pipe end section 12. In doing so, the retaining element 14 has been rotated in the direction of an arrow 49. As a result, the projections 38, 40, 42 engage behind the projections 22, 24, 26. In other words, as a result of the bayonet-like connection which is formed by said projections 22, 24, 26, 38, 40, 42, the possible movement of the retaining element 14 is axially limited (or axially fixed) in the direction of the pipe end 50 of the first pipe end section 12. The bayonet connection therefore prevents a movement of the retaining element 14 in the direction of an arrow 52. Furthermore, the bayonet-like connection can be designed so that it also prevents a movement in the opposite direction to the arrow 52.

FIG. 5 shows the connecting device 10, wherein the second pipe end section 13 is slid section-by-section onto the first pipe end section 12. Here, the sliding-on has taken place in the opposite direction to the arrow 52 (see FIG. 4). It can be seen from FIG. 5 that the strap 46 has a through-opening 54. The through-opening 54 is formed in the end region of the strap 46 which faces away from the fixing section 44. The through-opening 54 aligns with an opening 56 of the second pipe end section 13. A screw 58 can be partially fed through the through-opening 54 and partially inserted, i.e. screwed, into the opening 56 in order to fix the first pipe end section 12 to the second pipe end section 13.

The through-opening 54 is designed in the form of an elongated hole to enable play of the first pipe end section 12 along its longitudinal axis 28 (see FIG. 4) relative to the second pipe end section 13. In the present case, the through-opening 54 is designed so that the second pipe end section 13 can move towards the first pipe end section 12 but not away from the first pipe end section 12.

The strap 46 has a guide section 60 for resting against the second pipe end section 13. The guide section 60 runs substantially parallel to the longitudinal axis 28 (see FIG. 4) of the first pipe end section 12. The correct position of the strap 46 when fitting the connecting device 10 can be easily found by means of the guide section 60.

In summary, the invention relates to a connecting device for connecting two pipe end sections in a fluidically sealed manner. The connecting device has a retaining element which can be fitted by means of a bayonet connection to a first pipe end section. The retaining element has strap which can be fixed to a second pipe end section by means of a screw of the connecting device. The connecting device is therefore particularly simple from a constructive point of view, creates a sealed connection, and can also be fitted in restricted conditions.

What is claimed is:

1. A connecting device for the fluidic connection of a fluid pipe section to a further fluid pipe section, comprising:
the first fluid pipe section having a first pipe end section; and
the further fluid pipe section having a second pipe end section;
a connecting device for fluidically connecting and securing together the first pipe end section to the second pipe end section, the connecting device including:
a retaining element axially inserted onto and axially removable from the first pipe end section;
wherein the retaining element is configured and adapted to be rotated at least to a limited extent about a longitudinal axis of the first pipe end section;
wherein the retaining element is arranged on the first pipe end section;
a plurality of radially outwardly extending projections arranged on an outer circumference of the first pipe end section, the plurality of radially outwardly extending projections engaging with the retaining element to form a rotationally engagable axial position locking connection between the retaining element and the first pipe end section;
wherein the retaining element has a strap with a through-opening into which a screw of the retaining element is inserted; and
wherein the second pipe end section has an screw receiving opening into which the screw can be inserted to axially connect and axially positionally lock the fluid pipe section to the further fluid pipe section.

2. The connecting device as claimed in claim 1, wherein
the first pipe end section has at least one stop which limits the rotation of the retaining element about the first pipe end section.

3. The connecting device as claimed in claim 1, wherein
the retaining element has a fixing section which encompasses more than half of an outer circumference of the first pipe end section, the fixing section configured ad adapted to rotatably engage and mount the retaining element onto the first pipe end section.

4. The connecting device as claimed in claim 3, wherein
the fixing section is substantially ring-shaped and fully encompasses the circumference of the first pipe end section.

5. The connecting device as claimed in claim 1, wherein
the strap is made of sheet metal.

6. The connecting device as claimed in claim 5, wherein
the strap is formed unitarily with and in one piece with the fixing section of the retaining element.

7. The connecting device as claimed in claim 1, wherein
an elastic sealing element is arranged or formed between and sealing between the first pipe end section and the second pipe end section, the elastic sealing element fluidically sealing the connection between the first pipe end section and the second pipe end section.

8. The connecting device as claimed in claim 1, wherein
the first pipe end section is a charge air pipe; and
the second pipe section is an internal combustion engine turbocharger.

9. The connecting device as claimed in claim 1, wherein
the second pipe end section is a charge air pipe; and
the first pipe section is an internal combustion engine turbocharger.

10. The connecting device as claimed in claim 4, wherein
the strap is made of sheet metal and formed unitarily with and in one piece with the fixing section of the retaining element; and
wherein an elastic sealing element is arranged or formed between and sealing between the first pipe end section and the second pipe end section, the elastic sealing element fluidically sealing the connection between the first pipe end section and the second pipe end section.

11. A charge air pipe having a connecting device according to claim 1, wherein
the first fluid pipe section is a first charge air pipe end section for a turbocharger; and
the second fluid pipe section is a first charge air pipe end section for a turbocharger.
